(19) United States
(12) Patent Application Publication
(10) Pub. No.: US 2010/0244289 A1
(43) Pub. Date: Sep. 30, 2010

(54) Universal Valved Humidification Column

(76) Inventor: Gary Roth, Wake Forest, NC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/412,991

(22) Filed: Mar. 27, 2009

(51) Int. Cl. B01F 3/04

(52) U.S. Cl. 261/70; 261/141; 261/DIG. 65

(57) ABSTRACT

An embodiment in accordance with the present invention provides a humidifier including a universal, valved humidification column and a water reservoir for use with a breathing circuit. In accordance with the present invention, the universal valved humidification column includes a float valve which controls the water level in the column. Additionally, the water reservoir includes a gas permeable vent to control the pressure within the water reservoir.

### FIELD OF THE INVENTION

The present invention relates generally to medical apparatus. More particularly, the present invention relates to humidification columns for respiratory therapy systems.

### BACKGROUND OF THE INVENTION

Humidifiers are often incorporated into breathing circuits used for respiratory therapy, in order to humidify the gas directed to the patient. These humidifiers generally incorporate a cartridge-type humidifier positioned in a heater with water supplied from a pre-filled sterile reservoir. However, a sudden drop in pressure in the cartridge can cause water from the pre-filled sterile reservoir to rush into the cartridge, potentially causing flooding of the breathing circuit.

In U.S. Pat. Nos. 4,500,480 and 6,050,552, a water level sensing tube positioned in the humidification chamber communicates with the air space above the water level in the water supply reservoir via tubing with a one way valve. Water is fed into the humidification chamber from the bottom of the reservoir with tubing also including a one way valve. During continuous gas flow, if the humidification system is used with a CPAP system or is connected to a gas respirator or ventilator which directs respiratory gas into the humidification chamber under pressure, the pressure in the water supply reservoir equals the pressure to which the humidification chamber is exposed. Under certain conditions, however, the humidification chamber can be exposed to pressures of 150 cm H2O or more during continuous gas flow, or pressures in excess of 120 cm H2O during intermittent gas flow. This high pressure is ultimately transferred to the reservoir via the one way tubing, such that the pressure in the reservoir is near or equal to the mean pressure to which the humidification chamber is exposed. During typical operation such high pressures are not problematic, but a sudden pressure reduction in the humidification chamber can result in a rapid transfer of water from the reservoir and flooding of the chamber. The flooding of the chamber can also result in flooding of the breathing circuit tubing to which the humidification chamber is attached.

Some humidification column and water reservoir humidifier systems include several one way valves to relieve pressure within the water reservoir and also prevent an extreme pressure drop in the humidification column, and, in turn, prevent flooding of the breathing circuit. However, with these systems the humidification columns and water reservoirs cannot be used interchangeably, because the inlets and outlets for connecting the humidification column to the reservoir with the one way valves must be present in order for the system to work correctly.

One example of a humidification column and water reservoir humidification system is found in U.S. Pat. No. 7,228,859, issued on Jun. 12, 2007. This patent shows a humidification column and a water reservoir connected by several one way valves which form a pressure equalizing assembly or apparatus. The humidification column and water reservoir cannot however be used interchangeably in this system. Furthermore, various operational and functional deficiencies exist with this system.

Accordingly, it is desirable to provide a humidifier apparatus with a universal design for coupling to a breathing circuit, such that changes in pressure in the humidifier circuit do not affect the water level within the cartridge while isolating the water reservoir from the pressures seen inside the circuit. Isolation of the water reservoir from the circuit pressures also eliminates any compressible volumes within reservoir which may be seen with an open system and have a negative effect on patient respiratory gas volumes as delivered by the mechanical ventilator.

### SUMMARY OF THE INVENTION

The foregoing needs are met, to a great extent, by the present invention, wherein in one aspect a humidification apparatus is provided that in some embodiments includes a humidification column and a water reservoir.

In accordance with one aspect of the present invention, a humidification column for use with a breathing circuit includes a water container having an outer wall defining a top opening and a bottom surface of the water container. The water container can take a generally cylindrical shape. The bottom surface of the water container defines a water inlet. The outer wall of the water container defines a respiratory gas inlet and a respiratory gas outlet. A float valve is disposed at the bottom end of the water container such that water flowing through the water inlet into the water container is maintained below a predetermined level. Use of the float valve system of this design eliminates the circuit pressures from reaching the reservoir, thus eliminating possible over pressurization of the reservoir and flooding of the circuit.

In accordance with another aspect of the present invention, the water container includes a fixed lid to enclose the top opening of the water container. The lid can define the respiratory gas inlet and the respiratory gas outlet. A wicking material can be positioned in the column such that water in the column wets the wicking material. Additionally, the float valve can include a float valve housing and a plunger, and the plunger can be suspended from the float valve housing.

In accordance with another aspect of the present invention, a humidifier assembly for use with a breathing circuit includes a water supply container. The water supply container includes a water containing reservoir, and the water containing reservoir includes a water outlet and a gas permeable vent. The humidifier also includes a valved humidification column. The valved humidification column includes a water inlet, a respiratory gas inlet, a respiratory gas outlet, and a float valve disposed at a bottom end of the column. Water flowing through the water inlet into the water container is maintained below a predetermined level by the float valve. A water supply tubing connects the water supply container to the humidification column. The water supply tubing has a first end coupled to the water outlet of the water supply container and a second end coupled to the water inlet of the valved humidification column. The water supply tubing incorporates a one way valve in line which allows water flow into the humidification column from the reservoir, but prevents back flow of water from the humidification column back into the reservoir. Gas supply tubing connects the humidification column to a breathing circuit. The gas supply tubing has an end coupled to the respiratory gas outlet of the valved humidification column.

In accordance with another aspect of the present invention, the gas permeable vent can include a gas permeable vent spike positioned at the top of the water supply container or cam include a gas permeable vent added to the water inlet. The water supply container can take the form of a reservoir prefilled with water and further can take the form of a single use sterile water reservoir.

In accordance with still another aspect of the present invention, the water container includes a fixed lid to enclose the top opening of the water container. The lid can define the respiratory gas inlet and the respiratory gas outlet. A wicking material can be positioned in the column such that water in the column wets the wicking material. Additionally, the float valve can include a float valve housing and a plunger, and the plunger can be suspended from the float valve housing.

In accordance with another aspect of the present invention, a humidifier assembly for use with a breathing circuit includes a water supply container. The water supply container includes a water containing reservoir, and the water containing reservoir includes a water outlet and a gas permeable vent. The humidifier also includes a valved humidification column. The valved humidification column includes a water inlet, a respiratory gas inlet, a respiratory gas outlet, and a float valve disposed at a bottom end of the column. Water flowing through the water inlet into the water container is maintained below a predetermined level by the float valve. A water supply tubing connects the water supply container to the humidification column. The water supply tubing has a first end coupled to the water outlet of the water supply container and a second end coupled to the water inlet of the valved humidification column. The water supply tubing incorporates a one way valve in line which allow water flow into the humidification column from the reservoir, but prevents back flow of water from the humidification column back into the reservoir. Gas supply tubing connects the humidification column to a breathing circuit. The gas supply tubing has an end coupled to the respiratory gas outlet of the valved humidification column. The humidifier also can include a heater.

In accordance with another aspect of the present invention, the gas permeable vent can include a gas permeable vent spike positioned at the top of the water supply container or can include a gas permeable vent added to the water inlet. The water supply container can take the form of a reservoir prefilled with water and further can take the form of a single use sterile water reservoir.

In accordance with still another aspect of the present invention, the water container includes a fixed lid to enclose the top opening of the water container. The lid can define the respiratory gas inlet and the respiratory gas outlet. A wicking material can be positioned in the column such that water in the column wets the wicking material. Additionally, the float valve can include a float valve housing and a plunger, and the plunger can be suspended from the float valve housing.

### BRIEF DESCRIPTION OF THE DRAWINGS

FIG. 1 illustrates an example of the disposable components of a heated humidifier for use with a breathing circuit according to an embodiment of the invention.

FIG. 2 is a cross sectional view of the universal valved humidification column illustrated in FIG. 1, showing an open valve assembly of the humidification column in accordance with an embodiment of the invention.

FIG. 3 is a cross-sectional view of the universal, valved humidification column illustrated in FIGS. 1 and 2, showing a closed valve assembly of the humidification column in accordance with an embodiment of the invention.

### DETAILED DESCRIPTION

The invention will now be described with reference to the drawing figures, in which like reference numerals refer to like parts throughout. An embodiment in accordance with the present invention provides a universal, valved humidification column for a humidifier and a water reservoir for use with a breathing circuit. In accordance with the present invention, the universal valved humidification column includes a float valve which controls the water level in the column. Additionally, the water reservoir includes a gas permeable vent to control the pressure within the water reservoir.

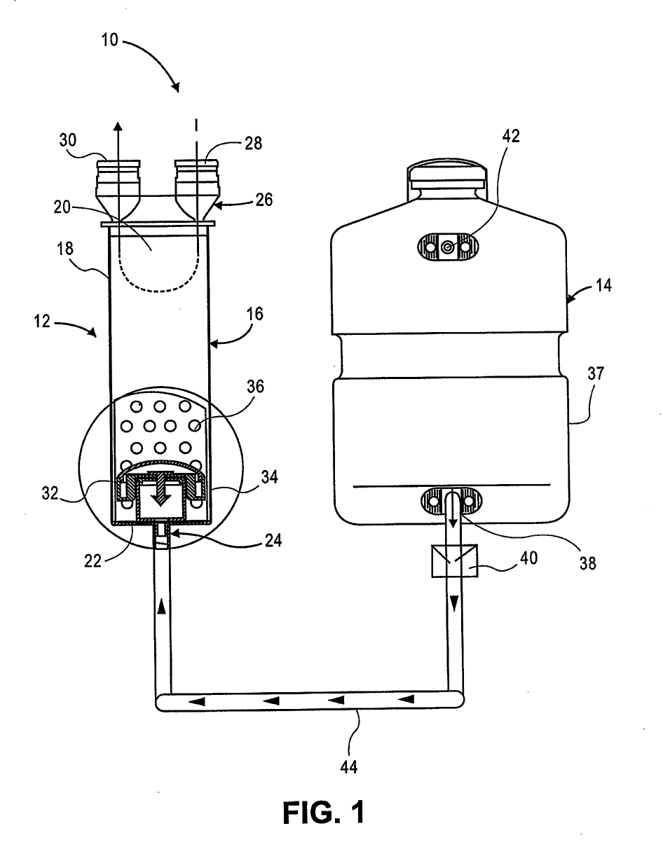

An embodiment of the present inventive apparatus is illustrated in FIG. 1. FIG. 1 illustrates a humidifier 10 including a universal, valved humidification column 12 connected to a water reservoir 14. The universal, valved humidification column 12 includes a water container 16 having a generally cylindrical outer wall 18. However, the outer wall 18 of the water container 16 may take any other suitable shape. The outer wall 16 defines a top opening 20 and a bottom surface 22 of the water container 16. The outer wall also defines a water inlet 24 at the bottom surface 22 of the water container 16.

The valved humidification column 12 also includes a lid 26 coupled to the top opening 20 of the water container 16. The lid 26 is sealingly coupled to the water container 16. The lid 26 defines a respiratory gas inlet 28 configured to couple to a breathing circuit. The lid 26 also defines a respiratory gas outlet 30 configured to couple to a breathing circuit, such that respiratory gas from a breathing circuit can travel into and out of the valved humidification column 12. Additionally, a float valve assembly 32 is disposed at the bottom end portion 34 of the water container 16 and wicking material 36 is positioned near the bottom end portion of container 16 at a predetermined height with respect to the water level within the water container 16. The wicking material 36 is positioned along an inner surface 19 of the outer wall 18, and can have a generally cylindrical configuration. Wicking material 36 can be a wicking paper mesh or sponge or other water absorbent material that also absorbs and transports water and moisture, such as, for example, through capillary action.

The humidifier system 10 also includes the water reservoir 14. The water reservoir 14 can come prefilled with water and can also take the form of a single-use, sterile water reservoir. The water reservoir 14 has an outer wall 37 defining a water outlet 38. The water outlet 38 includes a one way valve 40 which allows water within the water reservoir 14 to flow out of the reservoir 14 but does not allow water to flow back into the reservoir 14.

Because the humidifier system is connected to a ventilator, pressure in the valved humidification column 12 can increase. A spike in pressure in the valved humidification column 12 can cause a pressure differential between the valved humidification column 12 and the water reservoir 14. This pressure differential can, in turn, cause water to be rapidly transferred from the water reservoir 14 to the valved humidification column 12, which could also lead to undesirable flooding. Therefore, the present invention provides a system, apparatus and method to isolate the water reservoir 14 from the humidification column 12. The outer wall 37 of the water reservoir 14 can further include or define a gas permeable vent 42 designed to reduce pressure in the water reservoir 14 and eliminate any rapid transfer of water to the humidification column 12. The gas permeable vent 42 can take the form of a gas permeable vent spike positioned at the top of the water reservoir 14. The gas permeable vent 42 can also take the form of a gas permeable vent added to the water outlet 38.

Water supply tubing 44 having a first end coupled to the water inlet valve 24 of the humidification column 12 also has a second end coupled to the water outlet 38 of the water reservoir 14. Water held in the water reservoir 14 can flow through the tubing from the water reservoir 14 to the humidification column 12. However, water cannot flow from the humidification column 12 back to the water reservoir 14, because of the one way valve 40.

A sudden pressure reduction in the humidification column 12 can result in the rapid transfer of water from the water reservoir 14 and flooding of the humidification column 12, as explained above. Therefore, the float valve 32 assembly only allows water to flow into the humidification column 12 only to a predetermined level. This level is such that the water in the column dampens the wicking material 36, but cannot flood the column. The water level contact with the wicking material 36 enhances the absorption of water by gas traveling through the humidification column 12 because it increases the surface area of within the humidification column 12 which gas traveling through the humidification column 12 will come into contact with moisture, and helps to draw water up and into the column chamber. Therefore, the wicking material 36 improves the humidification function of the overall assembly. If the water level is too low, the valve 32 allows more water to flow into the column 12 to keep the wicking material 36 in constant contact with the water.

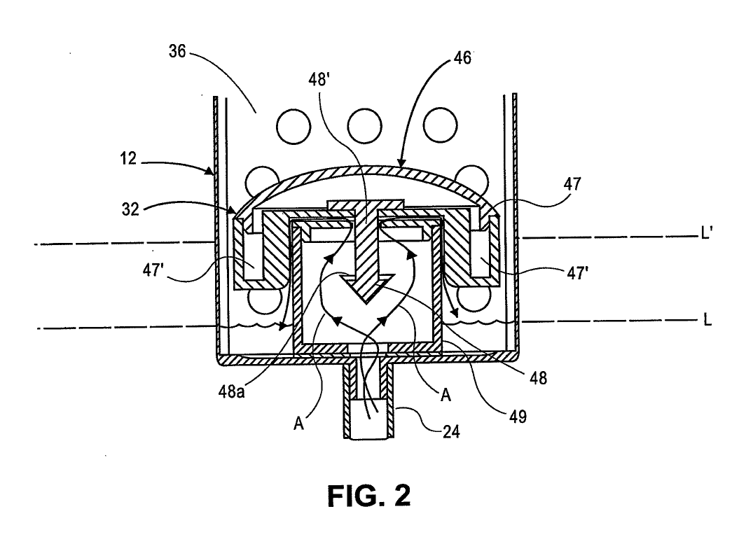

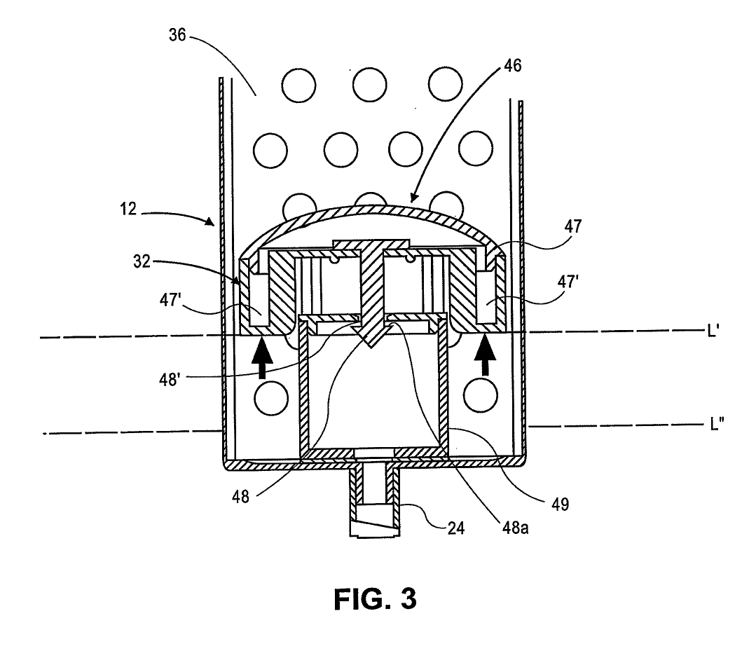

FIGS. 2 and 3 illustrate the valve assembly 32 of the universal, valved humidification column 12. As illustrated in FIGS. 2 and 3, the float valve assembly 32 includes a housing 46 which includes a top portion 47 and a bottom portion 49. The top portion 47 of the housing 46 can be generally dome shaped and defines at least one hollow enclosed volume 47′ such that the top portion 47 can float on top of water in the humidification column 12. The bottom portion 49 of the housing 46 fits within the top portion 47 of the housing, and a plunger 48 connects the top portion 46 of the housing 48 to the bottom portion 49. The plunger 48 is disposed through an opening 48′ defined by the bottom portion 49. When the float valve 32 is open the plunger 48 is suspended from the housing 46, allowing water to seep into the universal, valved humidification column 12. As water enters the column 12, the float valve housing 46 rises with the level of the water initially at line L in FIG. 2. When the water reaches a predetermined level L′, the top portion 47 of the valve housing 46 will be sufficiently raised, such that the valve housing 46 forces a flat seat or surface 48a on the plunger 48 against the housing to completely occlude opening 48′ and shuts off the flow of the water to the column 12.

The float valve 32 allows enough water into the column 12, such that the wicking material 36 is dampened. The wicking material 36 is positioned in the humidification column 12 such that when the water is at a minimum level L″ the wicking material 36 is in contact with the water and will draw the water up into the wicking material 36. The valved humidification column 12 can be disposed within a heater such that the water on the wicking material 36 is better evaporated by action of the heater. The wicking material 36 increases the surface area from which water in the humidification column 12 can be evaporated.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A disposable humidification column and water reservoir system for use with active heated humidifier in conjunction with a breathing circuit comprising:
a water container having an outer wall defining a top opening and a bottom portion;
a water inlet defined by the bottom portion;
a respiratory gas inlet defined by the outer wall;
a respiratory gas outlet defined by the outer wall of the water; and
a float valve disposed at the bottom portion of the water container such that water flowing through the water inlet into the water container is maintained below a predetermined level.

2. The humidification column of claim 1, wherein the water container is generally cylindrical in shape.

3. The humidification column of claim 1, wherein the water container comprises a fixed lid to enclose the top opening of the water container.

4. The humidification column of claim 3, wherein the lid defines the respiratory gas inlet.

5. The humidification column of claim 3, wherein the lid defines the respiratory gas outlet.

6. The humidification column of claim 1, wherein the valved humidification column comprises wicking material that absorbs water and is positioned proximate the float valve such that water in the column wets the wicking material.

7. The humidification column of claim 1, wherein the float valve comprises a float valve housing and a plunger.

8. The humidification column of claim 7, wherein the plunger is suspended from the float valve housing.

9. A humidifier assembly for use with a breathing circuit comprising:
a water supply container enclosing a water containing reservoir having a water outlet and a gas permeable vent;
a valved humidification column comprising a water inlet, a respiratory gas inlet, a respiratory gas outlet, and a float valve disposed at a bottom end of the water container such that water flowing through the water inlet into the water container is maintained below a predetermined level;
water supply tubing having a first end coupled to the water outlet of the water supply container and a second end coupled to the water inlet of the valved humidification column.

10. The humidifier assembly of claim 9, wherein the gas permeable vent further comprises a gas permeable vent spike positioned at the top of the water supply container.

11. The humidifier assembly of claim 9, wherein the gas permeable vent further comprises a gas permeable vent added to the water inlet.

12. The humidifier assembly of claim 9, wherein the water supply container comprises a reservoir prefilled with water.

13. The humidifier assembly of claim 9, wherein the water supply reservoir comprises a single use sterile water reservoir.

14. The humidifier assembly of claim 9, wherein the valved humidification column comprises wicking material positioned such that water in the column wets the wicking material.

15. The humidifier assembly of claim 9, wherein the float valve comprises a float valve housing and a plunger.

16. The humidifier assembly of claim 15, wherein the plunger is suspended from the float valve housing.

17. A humidifier assembly for use with a breathing circuit comprising:
a water supply container enclosing a water containing reservoir having a water outlet and a gas permeable vent;
a valved humidification column comprising a water inlet, a respiratory gas inlet, a respiratory gas outlet, and a float valve disposed at a bottom end of the water container such that water flowing through the water inlet into the water container is maintained below a predetermined level;
water supply tubing having a first end coupled to the water outlet of the water supply container and a second end coupled to the water inlet of the valved humidification column, wherein the water supply tubing comprises a one way valve, such that water flows from the water reservoir to the humidification column; and
gas supply tubing having an end coupled to the respiratory gas outlet of the valved humidification column.

18. The humidifier assembly of claim 17 wherein the gas permeable vent further comprises a gas permeable vent spike positioned at the top of the water supply container.

19. The humidifier assembly of claim 17 wherein the float valve comprises a float valve housing and a plunger.

20. The humidifier assembly of claim 19 wherein the plunger is suspended from the float valve housing.
